(19) United States
(12) Patent Application Publication
(10) Pub. No.: US 2014/0078056 A1
(43) Pub. Date: Mar. 20, 2014

(54) POINTER SPEED ADJUSTING METHOD AND DISPLAY SYSTEM USING THE SAME

(71) Applicants: Cheng-Cheng Yu, New Taipei City (TW); Chun-Chi Huang, New Taipei City (TW); Lien-Kai Chou, New Taipei City (TW)

(72) Inventors: Cheng-Cheng Yu, New Taipei City (TW); Chun-Chi Huang, New Taipei City (TW); Lien-Kai Chou, New Taipei City (TW)

(73) Assignee: AVer Information Inc., New Taipei city (TW)

(21) Appl. No.: 13/628,997

(22) Filed: Sep. 27, 2012

(30) Foreign Application Priority Data
Jan. 4, 2012 (TW) 101100358

(51) Int. Cl. G09G 5/08

(52) U.S. Cl. 345/157

(57) ABSTRACT

A pointer speed adjusting method is used in a display system including a pen-shaped pointing device and a display screen. The pointer speed adjusting method includes the following steps. Firstly, a moving trajectory of the pen-shaped pointing device is sensed. Then, a trajectory display pattern is obtained according to the moving trajectory. Then, the trajectory display pattern is compared with a reference display pattern shown on the display screen, so that an optical scale factor error is obtained. Afterwards, a speed conversion ratio is adjusted according to the optical scale factor error.

This application claims the benefit of Taiwan Patent Application No. 101100358, filed Jan. 4, 2012, the subject matter of which is incorporated herein by reference.

### FIELD OF THE INVENTION

The present invention relates to a pointer speed adjusting method, and more particularly to a pointer speed adjusting method for adjusting the pointer speed according to a reference display pattern. The present invention also relates to a display system using the pointer speed adjusting method.

### BACKGROUND OF THE INVENTION

Recently, with the increasing development of handwriting recognition technologies, the use of the pointing device (e.g. a pen mouse or an optical pen) becomes more popular. FIG. 1A schematically illustrates the relationship between a moving trajectory of a pen mouse and the corresponding input trajectory of a pointer shown on a display screen. As shown in FIG. 1A, the pen mouse 11 is operated to draw a crooked line. The pen mouse 11 has a built-in optical sensor to detect a moving trajectory 15 of the pen mouse 11. After the moving trajectory 15 of the pen mouse 11 is detected, the moving trajectory 15 is transmitted to a personal computer in a wired transmission manner or a wireless transmission manner. Consequently, a corresponding input trajectory 16 of the pointer (e.g. a cursor) is shown on a display screen 12 of the personal computer.

Generally, the current pen mouse 11 has a trajectory-correcting function for correcting the input trajectory 16 to be close to a combination of smooth lines. However, the operations of the pen mouse 11 still have some drawbacks.

The resolution of the pen mouse 11 may be indicated by dots per inch (DPI). A DPI value indicates the number of individual coordinate points that the optical sensor of the pen mouse 11 is received when the pen mouse 11 is moved on a physical surface within the span of one linear inch (or about 2.54 mm). For example, the resolution 800 DPI of the pen mouse 11 indicates that 800 different coordinate points are received by the optical sensor when the pen mouse 11 is moved for one inch. In addition, resolution 800 DPI of the pen mouse 11 corresponds to 800 dots on the image frame.

For example, if a pen mouse A has a resolution 200 DPI, the cursor shown on the display screen is moved for one dot when the pen mouse A is moved for 1/200 inch. Whereas, if a pen mouse B has a resolution 800 DPI, the cursor shown on the display screen is moved for one dot when the pen mouse A is moved for only 1/800 inch. In other words, as the resolution of the pen mouse 11 is increased, the input trajectory shown on the display screen is moved at a faster speed. Under this circumstance, the sensitivity of operating the pen mouse 11 is enhanced. Since the hand-eye coordination and response for different users are distinguished, the pen mouse 11 with the identical sensitivity settings is not always feasible to all users.

For example, if the resolution of the pen mouse 11 is 800 DPI, some users may feel the optical sensor of the pen mouse 11 held by the hand is too sensitive. Under this circumstance, even if the user feels that the pen mouse 11 is moved for a short distance, the input trajectory shown on the display screen is moved for a very long distance. On the other hand, if the resolution of the pen mouse 11 is 800 DPI, some other users may feel that the input trajectory shown on the display screen is moved at a slow speed. That is, some other users feel that the sensing speed of the pen mouse 11 is somewhat sluggish.

If the user feels that the sensing speed of the pen mouse 11 is too fast, the user may feel that the moving trajectory of the pen mouse 11 is too sensitive to be written. Whereas, if the feels that the sensing speed of the pen mouse 11 is too slow, the user may feel that the pen mouse 11 fails to be smoothly moved.

That is, the sensitivity of the optical sensor of the pen mouse 11 may influence the handwriting performance of different users. For allowing the sensing speed of the pen mouse 11 to match different moving speeds of the pen mouse 11, some ways of adjusting the sensing speed of the pen mouse 11 or the pointer speed on the display screen 12 have been disclosed.

FIG. 1B schematically illustrates a way of providing multi-stage sensing speeds of the pen mouse through button selection. As shown in FIG. 1B, the main body of the pen mouse 11 includes plural buttons 111a, 111b and 111c. The different buttons are correlated with respective resolution settings.

For example, the button 111a denotes the sensing speed corresponding to the resolution 200 DPI, the button 111b denotes the sensing speed corresponding to the resolution 400 DPI, and the button 111c denotes the sensing speed corresponding to the resolution 1600 DPI.

For complying with the handwriting habit, the user should try finding the optimal sensing speed by successively pushing the buttons. For example, if the pen mouse 11 has a preset sensing speed corresponding to the resolution 1000 DPI but the sensing speed corresponding to the resolution 1600 DPI is the optimal sensing speed matching the handwriting habit of the user A, the user has to successively push the buttons to feel the sensing speed until the button 111c is pushed to set the optimal sensing speed.

FIG. 10 schematically illustrates a way of providing multi-stage sensing speeds of the pen mouse through software settings. The user may successively select the pointer speed from the low speed to the high speed. If the user feels that the sensing speed of the pen mouse 11 is too high, the user may move the scroll bar shown on the display screen to a lower graduation. Since the step of adjusting the pointer speed should be repeatedly done, the way of setting the optimal sensing speed of the pen mouse is very troublesome.

Moreover, even if the pen mouse 11 is operated by the same user, the optimal resolution of the pen mouse may be varied according to different operating actions (e.g. the handwriting action or the drawing action). That is, if the operating action of the pen mouse 11 is changed, the above way of setting the optimal sensing speed of the pen mouse 11 or the pointer speed on the display screen 12 should be performed again.

Therefore, there is a need of providing an efficient method for adjusting the pointer speed.

### SUMMARY OF THE INVENTION

A first embodiment of the present invention provides a pointer speed adjusting method for use in a display system including a pen-shaped pointing device and a display screen. The pointer speed adjusting method includes the following steps. Firstly, a moving trajectory of the pen-shaped pointing device is sensed. Then, a trajectory display pattern is obtained according to the moving trajectory. Then, the trajectory display pattern is compared with a reference display pattern shown on the display screen, so that an optical scale factor error is obtained. Afterwards, a speed conversion ratio is adjusted according to the optical scale factor error.

A second embodiment of the present invention provides a display system. The display system includes a pen-shaped pointing device and a display screen. The pen-shaped pointing device includes a pen-shaped casing, a sensing unit and a transmitting unit. The sensing unit is located at a side of the pen-shaped casing for sensing a moving trajectory of the pen-shaped pointing device. The transmitting unit is electrically connected with the sensing unit for transmitting the moving trajectory sensed by the sensing unit. The display screen is in communication with the pen-shaped pointing device, and includes a receiving unit, a display unit and a controlling unit. The receiving unit is in communication with the transmitting unit for receiving the moving trajectory. The display unit is configured for showing a reference display pattern. The controlling unit is electrically connected to the receiving unit and the display unit. After a trajectory display pattern is calculated according to the moving trajectory by the controlling unit, the controlling unit compares the trajectory display pattern with the reference display pattern to obtain an optical scale factor error, and the controlling unit adjusts a speed conversion ratio according to the optical scale factor error.

A third embodiment of the present invention provides a display system. The display system includes a pen-shaped pointing device and a display screen. The pen-shaped pointing device includes a pen-shaped casing, a sensing unit, a converting unit and a transmitting unit. The sensing unit is located at a side of the pen-shaped casing for sensing a moving trajectory of the pen-shaped pointing device. The converting unit is electrically connected with the sensing unit, for converting the moving trajectory sensed by the sensing unit into a trajectory display pattern. The transmitting unit is electrically connected with the converting unit for transmitting the trajectory display pattern. The display screen is in communication with the pen-shaped pointing device, and includes a receiving unit, a display unit, and a controlling unit. The receiving unit is in communication with the transmitting unit for receiving the trajectory display pattern. The display unit is configured for showing a reference display pattern. The controlling unit is electrically connected to the receiving unit and the display unit. After the controlling unit compares the trajectory display pattern with the reference display pattern to obtain an optical scale factor error, the controlling unit adjusts a speed conversion ratio according to the optical scale factor error.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A (prior art) schematically illustrates the relationship between a moving trajectory of a pen mouse and the corresponding input trajectory shown on a display screen;

FIG. 1B (prior art) schematically illustrates a way of providing multi-stage sensing speeds of the pen mouse through button selection;

FIG. 1C (prior art) schematically illustrates a way of providing multi-stage sensing speeds of the pen mouse through software settings;

FIG. 2A schematically illustrates a reference display pattern and a sensing zone corresponding to the reference display pattern;

FIG. 2B schematically illustrates an input trajectory corresponding to a moving trajectory of a pen mouse made by a user;

FIG. 2C schematically illustrates a trajectory display pattern obtained according to the moving trajectory of the pen mouse;

FIG. 3A schematically illustrates the comparison between the reference display pattern shown on the display screen and the trajectory display pattern which is calculated by a first adjusting process;

FIG. 3B schematically illustrates the comparison between the reference display pattern shown on the display screen and the trajectory display pattern which is calculated by a second adjusting process;

FIG. 4 is a flowchart illustrating a pointer speed adjusting method according to an embodiment of the present invention; and

FIG. 5 is a schematic functional block diagram illustrating a display system according to an embodiment of the present invention.

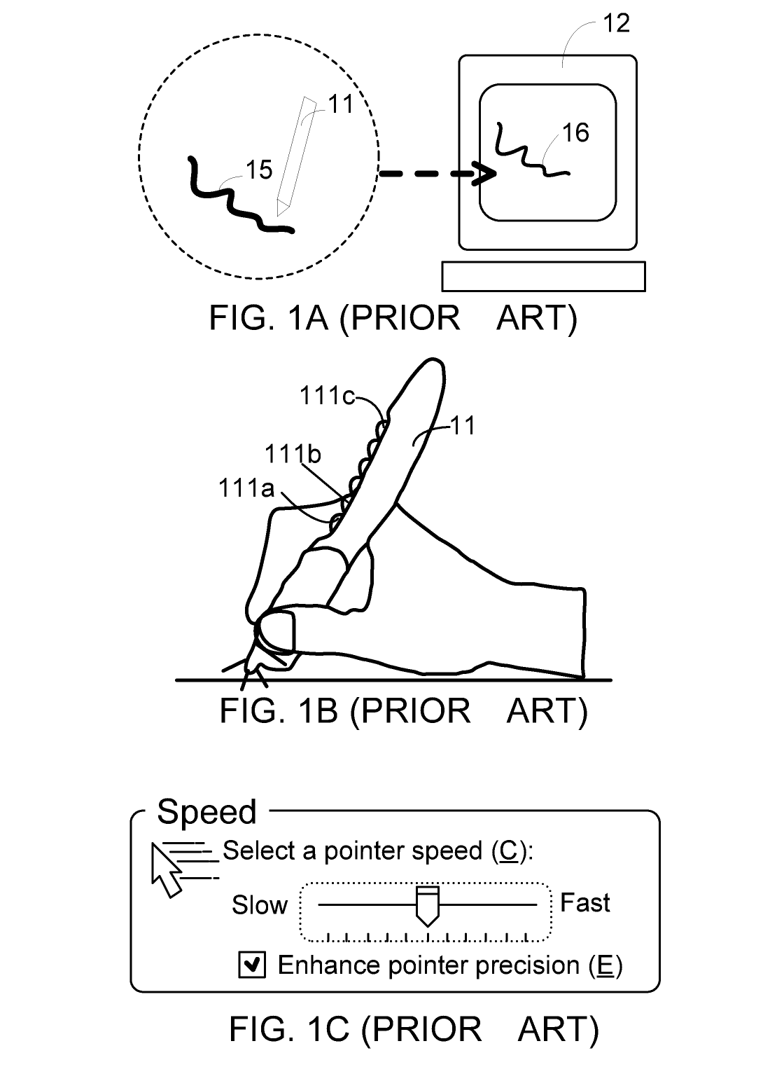

### DETAILED DESCRIPTION OF PREFERRED EMBODIMENTS

As previously described, since the moving speeds of the pen mouse operated by different users are distinguished, the conventional pen mouse provides a function of adjusting the resolution settings. That is, the user may successively change the resolution settings of the pen mouse in order to achieve the optimal sensing speed matching the handwriting habit of the user. As known, the conventional way of setting the optimal sensing speed of the pen mouse is very troublesome. Moreover, even if the pen mouse is operated by the same user, it is still necessary to change the resolution settings of the pen mouse according to different operating actions (e.g. the handwriting action or the drawing action). In other words, the way of adjusting the pointer speed by changing the resolution of the pen mouse is not user-friendly.

Therefore, there is a need of providing a method of adjusting the pointer speed according to the operating actions of the pen mouse or according to the habits of different users without the need of manually adjusting the resolution of the pen mouse.

The present invention provides a pointer speed adjusting method shown on a display screen. By the pointer speed adjusting method of the present invention, a reference display pattern is firstly provided, and then user may operate the pen mouse to create a moving trajectory on the display screen.

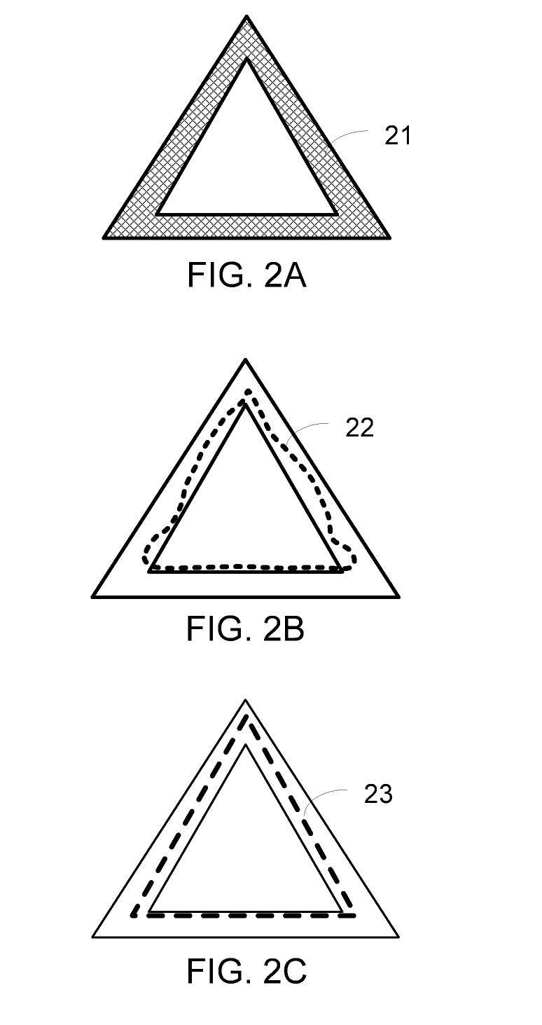

FIG. 2A schematically illustrates a reference display pattern and a sensing zone corresponding to the reference display pattern. As shown in FIG. 2A, the reference display pattern has a triangular profile. According to the reference display pattern, a triangular sensing zone 21 is provided for showing the moving trajectory of a pen mouse made by a user. It is noted that the shape of the reference display pattern is not restricted. For example, in some other embodiments, the reference display pattern may have a circular shape or rectangular shape.

FIG. 2B schematically illustrates an input trajectory corresponding to a moving trajectory of a pen mouse made by a user. According to the reference display pattern, the user may operate the pen mouse to create a triangular pattern. Since the triangular pattern is made by handwriting, the moving trajectory 22 is not smooth and straight.

FIG. 2C schematically illustrates a trajectory display pattern obtained according to the moving trajectory of the pen mouse. The trajectory display pattern 23 may be calculated according to the moving trajectory of the pen mouse by using a smoothing calculation. For example, the smoothing calculation includes an interpolation method, an extrapolation method, a curve fitting method, a regression analysis method or any other numerical analysis method. Of course, the way of performing the smoothing calculation in practice may be selected according to the system's requirements. If the system has satisfied performance, the complicated and precise smoothing calculation may be performed. Whereas, if the system has inferior performance, the smoothing calculation with larger error but faster computing speed may be performed.

For example, if the moving trajectory is a straight line, the smoothing calculation is performed by using a least square method. Whereas, if the moving trajectory is a curve line, the smoothing calculation is performed by using an interpolation method.

For example, the least square method of the regression analysis method may be used to simply calculate the unknown data, and the sum of the squares of the calculated data and the real data is minimized. By means of the least square method, the original curved and non-straight moving trajectory may be smoothed and homogenized. Consequently, the trajectory display pattern has a triangular profile close to the reference display pattern.

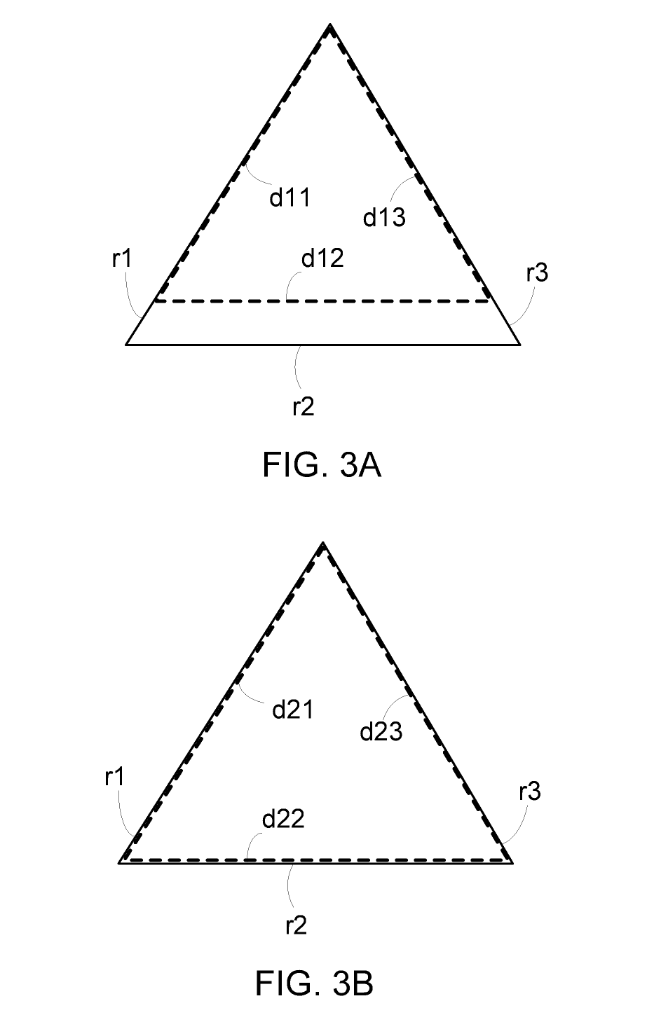

FIG. 3A schematically illustrates the comparison between the reference display pattern shown on the display screen and the trajectory display pattern which is calculated by a first adjusting process. As shown in FIG. 3A, the reference display pattern is composed of a first reference segment r1, a second reference segment r2 and a third reference segment r3. After the smoothing calculation is performed, the obtained trajectory display pattern is composed of a first display segment d11, a second display segment d12 and a third display segment d13.

As shown in FIG. 3A, the trajectory display pattern of the pen mouse made by the user does not highly match the reference display pattern because of an optical scale factor error. The optical scale factor error denotes the error between the moving trajectory of the pen mouse on the handwriting plane and the real display trajectory. For obtaining the optical scale factor error, the average error between the reference display pattern and the trajectory display pattern should be calculated.

The error between the reference display pattern and the trajectory display pattern includes a first segment error e1, a second segment error e2 and a third segment error e3. The first segment error e1 denotes the error between the first display segment d11 and the first reference segment r1. The second segment error e2 denotes the error between the second display segment d12 and the second display segment d12. The third segment error e3 denotes the error between the third display segment d13 and the third reference segment r3. That is, the first segment error e1=(d11−r1)/r1; the second segment error e2=(d12−r2)/r2; and the third segment error e3=(d13−r3)/r3.

The average error of all segments resulting from the optical error factor may be calculated by averaging the first segment error e1, the second segment error e2 and the third segment error e3. That is, average error e=(e1+e2+e3)/3.

In this context, a term “speed conversion ratio” indicates a ratio between a moving speed of the pen mouse and the pointer speed on the display screen. For different users or for different operating actions of the same user, an optimal speed conversion ratio may be determined according to the pointer speed adjusting method of the present invention. After the optimal speed conversion ratio is determined, the optimal pointer speed is determined because the moving speed of the pen mouse for the same user and the same operating action is fixed.

For example, if the preset speed conversion ratio is R0, after the first adjusting process is done, a new speed conversion ratio R1 is obtained. The new speed conversion ratio R1 is determined according to the preset speed conversion ratio and the average error e, i.e. R1=R0×(1+e). On the basis of the new speed conversion ratio R1, a second adjusting process similar to the first adjusting process is performed to obtain a new error between the reference display pattern and the new trajectory display pattern. According to the new error e, an updated speed conversion ratio R2 is obtained after the second adjusting process is done.

FIG. 3B schematically illustrates the comparison between the reference display pattern shown on the display screen and the trajectory display pattern which is calculated by a second adjusting process. The reference display pattern is identical to that of FIG. 3A. The reference display pattern is also composed of a first reference segment r1, a second reference segment r2 and a third reference segment r3. Since the speed conversion ratio has been adjusted after the first adjusting process, the adjusted speed conversion ratio is close to the optimal speed conversion ratio for the same user and for the same operating action.

After the smoothing calculation at the second time is performed, the obtained trajectory display pattern is composed of a first display segment d21, a second display segment d22 and a third display segment d23. Consequently, when compared with FIG. 3A, the trajectory display pattern of FIG. 3B can highly match the reference display pattern. That is, the adjusted speed conversion ratio R2 obtained by the second adjusting process is closer to the optimal speed conversion ratio than the adjusted speed conversion ratio R1 obtained by the first adjusting process. If the number of repeatedly performing the above adjusting process is increased, the difference between the adjusted speed conversion ratio and the optimal speed conversion ratio is decreased. From the above discussions, the optical scale factor error will be gradually decreased by repeatedly providing the reference display pattern for allowing the user to practice the handwriting process. In such way, the optimal speed conversion ratio can be obtained.

In the above embodiment, the optical scale factor error is obtained by calculating the average percentage difference between the reference segments and the corresponding display segments. It is noted that the method of obtaining the optical scale factor error is not restricted.

Alternatively, in some other embodiments, the optical scale factor error may be calculated by an optical scale factor error equation. Generally, the optical scale factor error equation is deduced as: Sᵣₑₐₗ=(1+ΔSF)×S_{optical}. In this equation, Sᵣₑₐₗ denotes the size of the reference display pattern (e.g. the perimeter of the reference display pattern), ΔSF denotes the optical scale factor error, and S_{optical} denotes the size of the trajectory display pattern (e.g. the perimeter of the trajectory display pattern). After the size of the reference display pattern (i.e. Sᵣₑₐₗ) and the size of the trajectory display pattern (i.e. S_{optical}) are measured, the optical scale factor error can be obtained according to the optical scale factor error equation.

In some embodiments, after the optical scale factor error is calculated, the optical scale factor error may be precisely estimated by a prediction mathematic algorithm. For example, the prediction mathematic algorithm is performed by a least square method, an adaptive filter or a Kalman filter.

From the above discussions, the present invention provides a pointer speed adjusting method. The pointer speed adjusting method includes the following steps. Firstly, a reference display pattern (e.g. a triangular pattern) is provided. Then, the user moves the pen mouse along a moving trajectory according to the reference display pattern, so that a corresponding trajectory display pattern is shown on the display screen. By comparing the trajectory display pattern with the reference display pattern, an optical scale factor error is obtained. Then, the speed conversion ratio between the moving speed of the pen mouse and the pointer speed is adjusted according to the optical scale factor error. Meanwhile, an adjusting process is completed. Since the moving speed of the pen mouse for the same user and for the same operating action is substantially fixed, after the speed conversion ratio is adjusted, the pointer speed on the display screen is correspondingly adjusted. If the pointer speed is satisfied by the user, the optimal pointer speed is determined. Whereas, if the pointer speed is not satisfied, the above adjusting process may be repeatedly done until the pointer speed on the display screen is satisfied by the user.

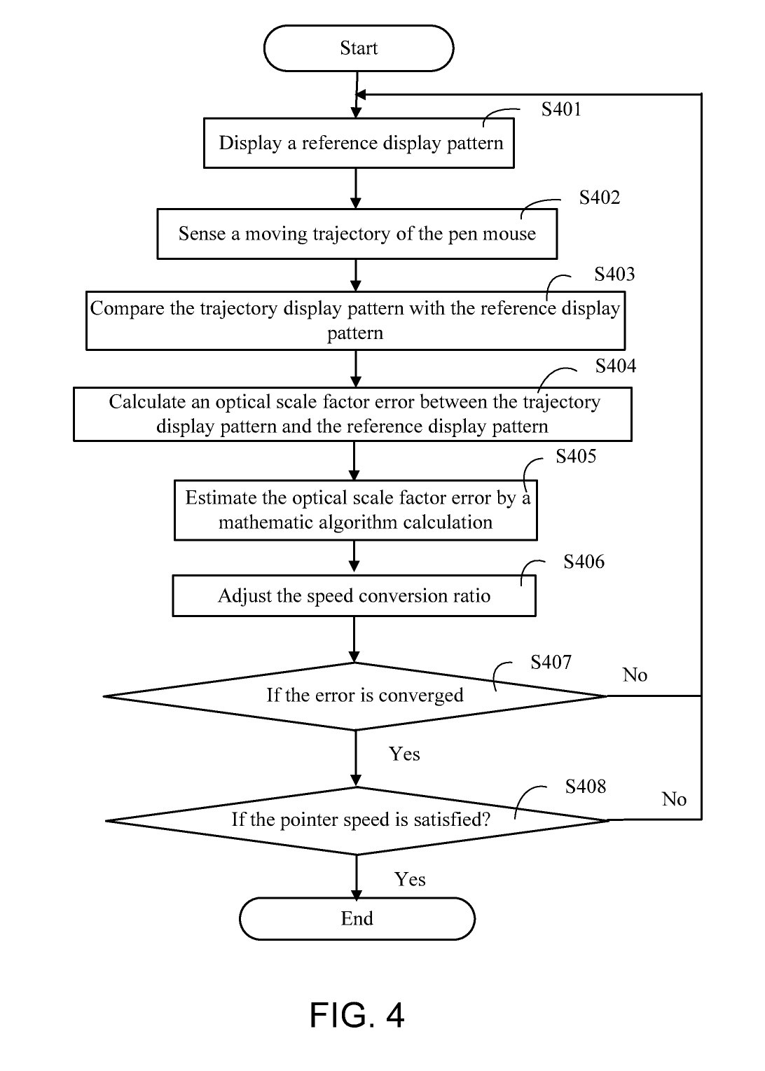

Hereinafter, a pointer speed adjusting method of the present invention will be illustrated by reference to the flowchart of FIG. 4.

FIG. 4 is a flowchart illustrating a pointer speed adjusting method according to an embodiment of the present invention.

Firstly, a reference display pattern is shown on the display screen (Step S401). Then, a moving trajectory of the pen mouse is sensed by a sensing unit of the pen mouse, and a trajectory display pattern is obtained according to the moving trajectory of the pen mouse (Step S402). Then, the trajectory display pattern is compared with the reference display pattern (Step S403). According to the comparing result, an optical scale factor error between the trajectory display pattern and the reference display pattern is acquired (Step S404). Optionally, after the step S404 is done, the optical scale factor error may be precisely estimated by a prediction mathematic algorithm (Step S405). For example, if the adaptive filter is used, the signal filtering function may be performed by automatically adjusting the performance according to the input signal. Whereas, if the Kalman filter is used, this high-efficiency regression filter (auto regression filter) can estimate the status of the dynamic system from a series of incomplete and noise-containing measurements.

Then, in the step S406, the speed conversion ratio is adjusted according to the optical scale factor error. After the speed conversion ratio is adjusted, the above adjusting process is repeatedly done, and a new optical scale factor error is obtained. Then, the new optical scale factor error is compared with the previous optical scale factor error to determine whether the new optical scale factor error is converged (Step S407). If the new optical scale factor error is converged, the user may further judge whether the pointer speed on the display screen is satisfied (Step S408). If the pointer speed on the display screen is satisfied, the flowchart of the pointer speed adjusting method is ended. Meanwhile, the speed conversion ratio is determined as the optimal speed conversion ratio. In a case that the judging conditions in the steps S407 and S408 are not satisfied, the above steps from the step S401 are performed again.

From the above discussions, the speed conversion ratio is adjusted according to the optical scale factor error (in the step S406). That is, the speed conversion ratio is compensated by the optical scale factor error. Since the moving speed of the pen mouse for the same user and the same operating action may be considered as a fixed value, after the speed conversion ratio is adjusted, the pointer speed is correspondingly adjusted. In a case that the adjusted pointer speed on the display screen is satisfied by the user, the pointer shown on the display screen is moved at the adjusted pointer speed in response to subsequent movement of the pen mouse. Consequently, the efficacy of the hand-eye coordination by operating the pen mouse will be largely enhanced.

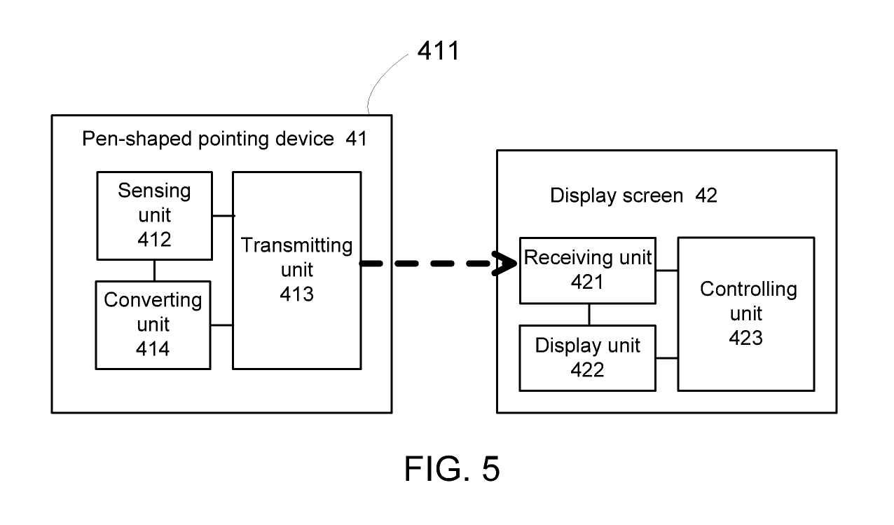

FIG. 5 is a schematic functional block diagram illustrating a display system according to an embodiment of the present invention. As shown in FIG. 5, the display system includes a pen-shaped pointing device 41 and a display screen 42. The pen-shaped pointing device 41 and the display screen 42 are in communication with each other. The pen-shaped pointing device 41 is for example an optical pen or a pen mouse.

As shown in FIG. 5, the display screen 42 includes a receiving unit 421, a display unit 422, and a controlling unit 423. The controlling unit 423 is electrically connected with the receiving unit 421 and the display unit 422 for controlling operations of the receiving unit 421 and the display unit 422.

When the pointer speed adjusting method of the present invention is activated, a reference display pattern is firstly shown on the display unit 422 of the display screen 42. After the reference display pattern is shown on the display screen 42, the user may move the pen-shaped pointing device 41 on a handwriting plane (not shown) along a trajectory according to the reference display pattern.

Since the moving trajectory of the pen-shaped pointing device 41 is not smooth and straight, after the moving trajectory is acquired by the receiving unit 421, the controlling unit 423 performs a smoothing calculation (e.g. a least square method) to obtain a trajectory display pattern according to the moving trajectory of the pen mouse.

Please refer to FIG. 5 again. The pen-shaped pointing device 41 includes a pen-shaped casing 411, a sensing unit 412, and a transmitting unit 413. Optionally, the pen-shaped pointing device 41 further includes a converting unit 414. The converting unit 414 is electrically connected with the sensing unit 412 and the transmitting unit 413.

The sensing unit 412 of the pen-shaped pointing device 41 is located at a side of the pen-shaped casing 411. The sensing unit 412 is used for detecting the moving trajectory of the pen-shaped casing 411 in an optical sensing manner. After the information about the moving trajectory of the pen-shaped casing 411 is transmitted to the converting unit 414, the information about the moving trajectory of the pen-shaped casing 411 is transmitted from the converting unit 414 to the receiving unit 421 of the display screen 42 through a data line or in a wired or wireless transmission manner.

The converting unit 414 of the pen-shaped pointing device 41 may be used for converting moving trajectory into the trajectory display pattern. It is noted that the device for converting the moving trajectory into the trajectory display pattern is not limited to the converting unit 414. For example, in some embodiments, the controlling unit 423 of the display screen 42 may be used for converting the sensed moving trajectory into the trajectory display pattern. Moreover, after the sensed moving trajectory is converted into the trajectory display pattern by the adjusting process, the trajectory display pattern may be selectively shown on the display screen 42 or not shown on the display screen 42. Alternatively, in some embodiments, only the trajectory display pattern corresponding to the newly-updated moving trajectory is shown on the display screen 42.

The pointer speed adjusting method implemented by the display system of the present invention includes the following steps. Firstly, a reference display pattern is provided. Then, the user moves the pen-shaped casing 411 along a first moving trajectory according to the reference display pattern, so that a corresponding first trajectory display pattern is created. By comparing the first trajectory display pattern with the reference display pattern, a first optical scale factor error is obtained. Then, the speed conversion ratio between the moving speed of the pen-shaped casing 411 and the pointer speed is adjusted according to the first optical scale factor error. After the speed conversion ratio is adjusted, the pointer speed on the display screen is correspondingly adjusted. If the pointer speed is not satisfied, the user may move the pen-shaped casing 411 along a second moving trajectory according to the reference display pattern, so that a corresponding second trajectory display pattern is created. By comparing the second trajectory display pattern with the reference display pattern, a second optical scale factor error is obtained. Then, the speed conversion ratio between the moving speed of the pen-shaped casing 411 and the pointer speed is adjusted according to the second optical scale factor error.

Since the speed conversion ratio is automatically adjusted by the pointer speed adjusting method of the present invention, the second trajectory display pattern is closer to the reference display pattern than the first trajectory display pattern. If the second optical scale factor error is converged relative to the first optical scale factor error and the current pointer speed is acceptable by the user, the pointer speed adjusting method is completed. Otherwise, if the second optical scale factor error is not converged or the current pointer speed is not acceptable by the user, the pointer speed adjusting method is performed again.

From the above descriptions, by the pointer speed adjusting method of the present invention, the speed conversion ratio between the moving speed of the pen-shaped casing and the pointer speed can be adjusted according to the handwriting habit of the user and the operating action of the pen-shaped pointing device. Regardless of whether the pen-shaped pointing device is used by different users or the different operating actions of the pen-shaped pointing device are made by the same user, the pointer speed adjusting method of the present invention can be employed to determine the optimal pointer speed. After the pointer speed adjusting method for the same user and the same operating action is done, the pointer shown on the display screen will be changed to the optimal pointer speed in response to the subsequent operations of the pen-shaped pointing device. It is not necessary to perform the pointer speed adjusting method again until the user or the operating action is changed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A pointer speed adjusting method for use in a display system including a pen-shaped pointing device and a display screen, the pointer speed adjusting method comprising steps of:
sensing a moving trajectory of the pen-shaped pointing device;
obtaining a trajectory display pattern according to the moving trajectory;
comparing the trajectory display pattern with a reference display pattern shown on the display screen, thereby obtaining an optical scale factor error; and
adjusting a speed conversion ratio according to the optical scale factor error.

2. The pointer speed adjusting method as claimed in claim 1, wherein the speed conversion ratio is a ratio between a moving speed of the pen-shaped pointing device and a pointer speed on the display screen.

3. The pointer speed adjusting method as claimed in claim 1, wherein the trajectory display pattern is obtained according to the moving trajectory by a smoothing calculation, wherein the smoothing calculation is performed by an interpolation method, an extrapolation method, a curve fitting method or a regression analysis method.

4. The pointer speed adjusting method as claimed in claim 3, wherein if the moving trajectory is a straight line, the smoothing calculation is performed by using a least square method of the regression analysis method, wherein if the moving trajectory is a curve line, the smoothing calculation is performed by using the interpolation method.

5. The pointer speed adjusting method as claimed in claim 1, wherein the optical scale factor error is obtained according to the trajectory display pattern and the reference display pattern by an optical scale factor error equation.

6. The pointer speed adjusting method as claimed in claim 1, wherein the optical scale factor error is obtained according to the trajectory display pattern and the reference display pattern by a prediction mathematic algorithm.

7. The pointer speed adjusting method as claimed in claim 6, wherein the prediction mathematic algorithm is performed by an adaptive filter or a Kalman filter.

8. A display system, comprising:
a pen-shaped pointing device comprising a pen-shaped casing, a sensing unit and a transmitting unit, wherein the sensing unit is located at a side of the pen-shaped casing for sensing a moving trajectory of the pen-shaped pointing device, and the transmitting unit is electrically connected with the sensing unit for transmitting the moving trajectory sensed by the sensing unit; and
a display screen in communication with the pen-shaped pointing device, and comprising a receiving unit, a display unit and a controlling unit, wherein the receiving unit is in communication with the transmitting unit for receiving the moving trajectory, the display unit is configured for showing a reference display pattern, and the controlling unit is electrically connected to the receiving unit and the display unit, wherein after a trajectory display pattern is calculated according to the moving trajectory by the controlling unit, the controlling unit compares the trajectory display pattern with the reference display pattern to obtain an optical scale factor error, and the controlling unit adjusts a speed conversion ratio according to the optical scale factor error.

9. The display system as claimed in claim 8, wherein the speed conversion ratio is a ratio between a moving speed of the pen-shaped casing and a pointer speed on the display screen.

10. The display system as claimed in claim 8, wherein the trajectory display pattern is obtained according to the moving trajectory by a smoothing calculation, wherein the smoothing calculation is performed by an interpolation method, an extrapolation method, a curve fitting method or a regression analysis method.

11. The display system as claimed in claim 10, wherein if the moving trajectory is a straight line, the smoothing calculation is performed by using a least square method of the regression analysis method, wherein if the moving trajectory is a curve line, the smoothing calculation is performed by using the interpolation method.

12. The display system as claimed in claim 8, wherein the optical scale factor error is obtained according to the trajectory display pattern and the reference display pattern by an optical scale factor error equation.

13. The display system as claimed in claim 8, wherein the optical scale factor error is obtained by a prediction mathematic algorithm, wherein the prediction mathematic algorithm is performed by an adaptive filter or a Kalman filter.

14. A display system, comprising:
a pen-shaped pointing device comprising a pen-shaped casing, a sensing unit, a converting unit and a transmitting unit, wherein the sensing unit is located at a side of the pen-shaped casing for sensing a moving trajectory of the pen-shaped pointing device, the converting unit is electrically connected with the sensing unit for converting the moving trajectory sensed by the sensing unit into a trajectory display pattern, and the transmitting unit is electrically connected with the converting unit for transmitting the trajectory display pattern; and
a display screen in communication with the pen-shaped pointing device, and comprising a receiving unit, a display unit, and a controlling unit, wherein the receiving unit is in communication with the transmitting unit for receiving the trajectory display pattern, the display unit is configured for showing a reference display pattern, and the controlling unit is electrically connected to the receiving unit and the display unit, wherein after the controlling unit compares the trajectory display pattern with the reference display pattern to obtain an optical scale factor error, the controlling unit adjusts a speed conversion ratio according to the optical scale factor error.

15. The display system as claimed in claim 14, wherein the speed conversion ratio is a ratio between a moving speed of the pen-shaped casing and a pointer speed on the display screen.
